(19) United States
(12) Patent Application Publication
(10) Pub. No.: US 2024/0098747 A1
(43) Pub. Date: Mar. 21, 2024

(54) Transmitting Periodic Cadence Reports to a Network

(71) Applicant: Apple Inc., Cupertino, CA (US)

(72) Inventors: Christian HOFMANN, Muenchen (DE); Panagiotis BOTSINIS, Munich (DE); Sameh M. ELDESSOKI, Munich (DE); Tarik TABET, Carlsbad, CA (US)

(21) Appl. No.: 17/933,922

(22) Filed: Sep. 21, 2022

(51) Int. Cl. H04W 72/12; H04W 72/14

(52) U.S. Cl. CPC H04W 72/1284; H04W 72/14

(57) ABSTRACT

A user equipment (UE) is configured to transmit a medium access control (MAC) control element (CE) comprising a periodic cadence report (PCR) to a network, wherein the PCR indicates one or more characteristics of upcoming uplink traffic and receive an uplink grant for a data transmission from the network, wherein the uplink grant indicates uplink resources assigned to the UE based on the PCR.

### BACKGROUND INFORMATION

A user equipment (UE) may establish a connection to a 5G New Radio (NR) network. In 5G NR, uplink (UL) grant based scheduling may be performed using a scheduling request (SR) mechanism or a configured grant (CG) mechanism. It has been identified that improvements are needed to make UL grant based scheduling faster, more application aware and more dynamic.

### SUMMARY

Some exemplary embodiments are related to a processor of a user equipment (UE) configured to perform operations. The operations include transmitting a medium access control (MAC) control element (CE) comprising a periodic cadence report (PCR) to a network, wherein the PCR indicates one or more characteristics of upcoming uplink traffic and receiving an uplink grant for a data transmission from the network, wherein the uplink grant indicates uplink resources assigned to the UE based on the PCR.

Other exemplary embodiments are related to a base station processor configured to perform operations. The operations include receiving, from a user equipment (UE), a medium access control (MAC) control element (CE) comprising a periodic cadence report (PCR) that indicates one or more characteristics of upcoming uplink traffic from the UE and transmitting an uplink grant for a data transmission to the UE, wherein the uplink grant indicates one or more uplink resources assigned to the UE based on the PCR.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a call flow for a service specific scheduling request (SR) according to various exemplary embodiments.

FIG. 5 shows examples of multiple SR configurations according to various exemplary embodiments.

FIG. 6 shows an exemplary call flow according to various exemplary embodiments.

FIG. 7 shows a call flow for a dynamic grant scheme using a periodic cadence report (PCR) according to various exemplary embodiments.

FIG. 8 shows a call flow for a configured grant scheme using a PCR according to various exemplary embodiments.

FIG. 9 shows examples of PCR medium access control (MAC) control elements (CEs) according to various exemplary embodiments.

FIG. 10 shows a call flow for a PCR scheme using a periodic cadence report prohibit timer according to various exemplary embodiments.

FIG. 11 shows a call flow for a hybrid scheme utilizing both service specific SR and PCR according to various exemplary embodiments.

### DETAILED DESCRIPTION

The exemplary embodiments may be further understood with reference to the following description and the related appended drawings, wherein like elements are provided with the same reference numerals. The exemplary embodiments introduce enhancements for uplink (UL) grant based scheduling.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

The exemplary embodiments are also described with regard to a 5G New Radio (NR) network and a next generation Node B (gNB). However, the reference to the 5G NR network and the gNB are provided for illustrative purposes. The exemplary aspects may apply to any type of network that utilizes uplink grant scheduling, including networks associated with further generations of cellular standards, e.g., 6G networks, etc.

According to some aspects of the present disclosure, the exemplary embodiments introduce service specific scheduling requests (SRs). As will be described in more detail below, in contrast to a SR mechanism that relies on a buffer status report (BSR) for resource planning and allocation, the exemplary service specific SR scheme uses different SRs to request resources for different services and/or applications. The exemplary embodiments include UE side and network side operations to support the implementation of service specific SRs. The exemplary service specific SR and corresponding techniques described herein may minimize latency, reduce signaling overhead and minimize complexity.

According to other aspects of the present disclosure, the exemplary embodiments introduce a periodic cadence report (PCR) that allows the UE to provide information to the network about upcoming traffic. For example, various applications and/or services running on the UE may know certain characteristics of upcoming traffic in advance (e.g., number of streams, cadence, packet size, jitter constraints, etc.). As will be described in more detail below, the UE may provide a PCR to the network to convey information about upcoming traffic characteristics. This information may be used by the network for uplink scheduling. The exemplary service specific SRs and techniques described herein may minimize latency, reduce signaling overhead and minimize complexity. Each of the exemplary embodiments introduced herein may be used independently from one another, in conjunction with other currently implemented uplink scheduling mechanisms, future implementations of uplink scheduling mechanisms or independently from other uplink scheduling mechanisms.

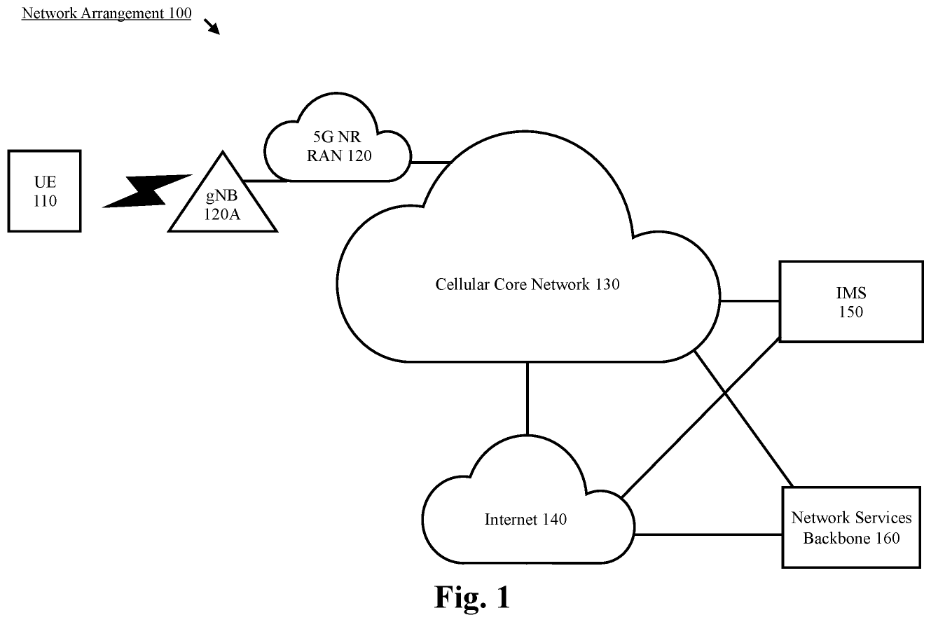

FIG. 1 shows an exemplary network arrangement 100 according to various exemplary embodiments. The exemplary network arrangement 100 includes a UE 110. Those skilled in the art will understand that the UE may be any type of electronic component that is configured to communicate via a network, e.g., a component of a connected car, a mobile phone, a tablet computer, a smartphone, a phablet, an embedded device, a wearable, an Internet of Things (IoT) device, etc. It should also be understood that an actual network arrangement may include any number of UEs being used by any number of users. Thus, the example of a single UE 110 is merely provided for illustrative purposes.

The UE 110 may communicate with one or more networks. In the example of the network arrangement 100, the networks with which the UE 110 may wirelessly communicate are a 5G NR radio access network (5G NR-RAN) 120. However, the UE 110 may also communicate with other types of networks (e.g., next generation (NG)-RAN, 5G cloud RAN, 6G RAN, legacy cellular networks, wireless local area network (WLAN), etc.) and the UE 110 may also communicate with networks over a wired connection. With regard to the exemplary embodiments, the UE 110 may establish a connection with the 5G NR-RAN 120.

The 5G NR-RAN 120 may be a portion of a cellular network that may be deployed by cellular providers (e.g., Verizon, AT&T, T-Mobile, etc.). The networks 120 may include, for example, base stations or nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., the gNB 120A).

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

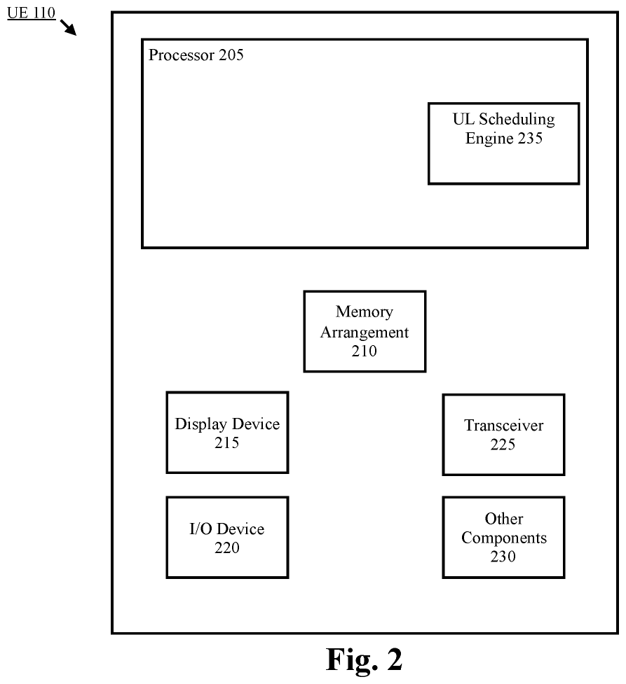

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a UL scheduling engine 235 for performing operations such as, but not limited to, transmitting service specific scheduling requests, transmitting PCR and receiving UL scheduling information.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120. Accordingly, the transceiver 225 may operate on a variety of different frequencies or channels (e.g., set of consecutive frequencies).

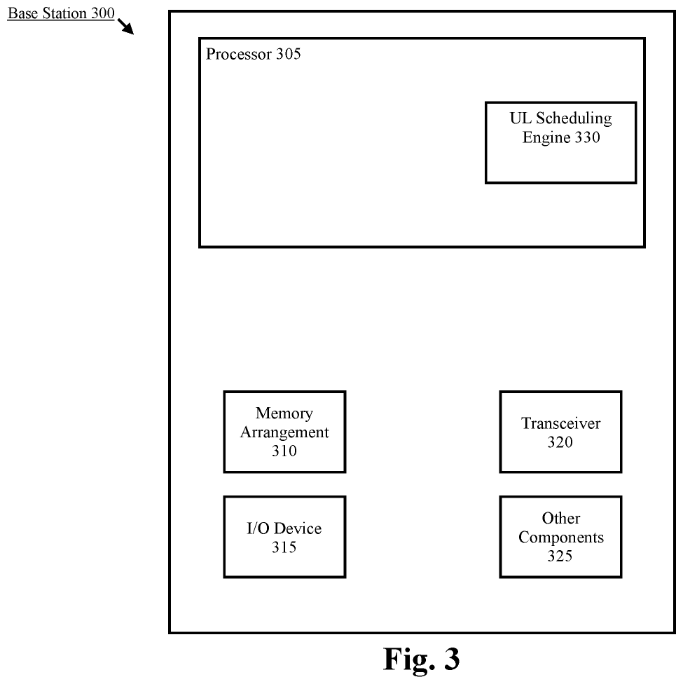

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320, other components 325. The other components 325 may include, for example, an audio input device, an audio output device, a battery, a data acquisition device, ports to connect the base station 300 to other electronic devices, etc.

The processor 305 may be configured to execute a plurality of engines for the base station 300. For example, the engines may include an UL scheduling engine 330. The UL scheduling engine 330 may perform operations such as, but not limited to, receiving service specific scheduling requests, receiving PCRs and transmitting UL scheduling information to UEs.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the UE 110. The I/O device 315 may be a hardware component or ports that enable a user to interact with the base station. The transceiver 320 may be a hardware component configured to exchange data with the UE 110 and any other UE in the system 100. The transceiver 320 may operate on a variety of different frequencies or channels (e.g., set of consecutive frequencies). Therefore, the transceiver 320 may include one or more components (e.g., radios) to enable the data exchange with the various networks and UEs.

According to some aspects, the exemplary embodiments introduce service specific SRs. As will be described in more detail below, the network may implement multiple SR configurations for different applications, services, quality of service (QoS) flows, traffic profiles, any combination thereof, etc. Throughout this description, the term “service specific SR” refers to a SR that is specific to one of multiple different SR configurations provided by the network. Thus, “service specific SR” does not necessarily mean a SR corresponding to a specific service but rather a SR for a specific SR configuration which corresponds to one or more services, one or more applications, one or more QoS Flows, one or more traffic profiles, any other appropriate type of parameter or any combination thereof.

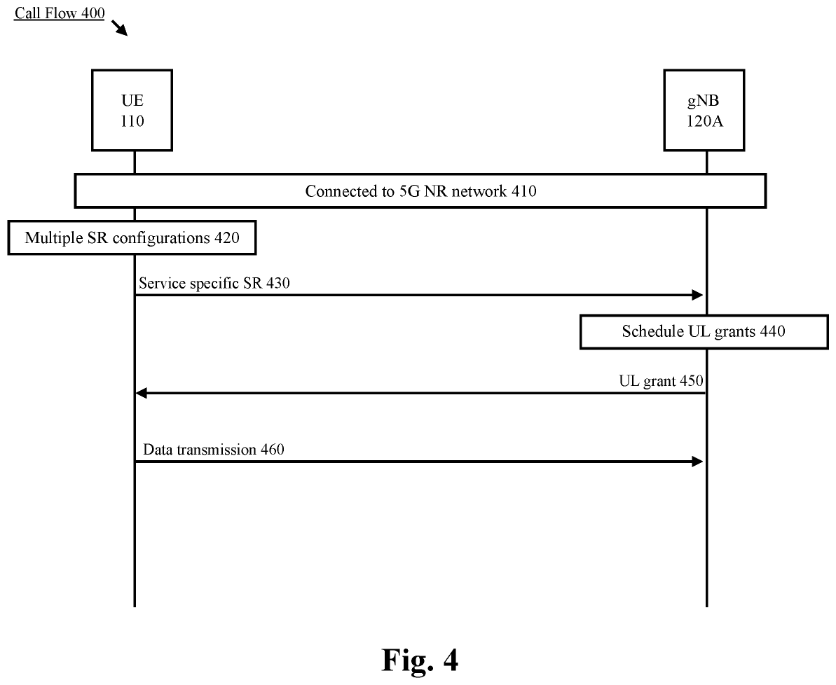

FIG. 4 shows a call flow 400 for a service specific scheduling request (SR) according to various exemplary embodiments. The call flow 400 is described relative to the network arrangement 100 of FIG. 1 and includes the UE 110 and the gNB 120A of the 5G NR-RAN 120. However, as mentioned above, the exemplary embodiments are not limited to 5G NR and may be utilized with any appropriate type of network (e.g., 5G, 6G, etc.).

Initially, assume that the UE 110 has service information related to UL traffic for which the UE 110 may send SRs to the gNB 120A. As will be described in greater detail below, the service information may refer to information explicitly or implicitly indicated by a service specific SR that is to be used by the network for UL scheduling. For example, the gNB 120A may select an UL grant pattern for a specific service, application, traffic profile, etc. This may allow the network to provide the UE 110 with UL grants that are tailored to the specific UL needs of the applications/services running on the UE 110.

In 410, the UE 110 is connected to the 5G NR RAN 120 via the gNB 120A. In 420, the UE 110 is configured multiple SR configurations. From the perspective of the UE 110, the different SR configurations may be derived from a SIM card, network settings, configuration information provided by the network, any combination thereof, etc.

Each SR configuration may have a different time domain configuration (e.g., slot location, etc.), a different frequency domain configuration (e.g., physical resource block (PRB) location, etc.) and/or a different cyclic shift for the physical uplink control channel (PUCCH) sequence. As will be described in greater detail below, in response to UL data arrival from an application or service running on the UE 110, the UE 110 may send a service specific SR corresponding to one of the multiple SR configurations. The network may then assign uplink grants to the UE 110 in response to the service specific SR.

In 430, the UE 110 transmits a service specific SR to the gNB 120A. For example, a service or application running on the UE 110 may generate data that is to be transmitted to a remote server. In response to the arrival of UL data at the UE 110, the UE 110 may transmit a service specific SR corresponding to the service or application that generated the data.

In 430, the UE 110 transmits a service specific SR to the gNB 120A. In this example, the service specific SR may include service information related to a specific service (e.g., service X). Since there are multiple different SR configurations, a service specific SR may include more information specific to the upcoming traffic. However, as indicated above, the service specific scheduling is not required to be specific to a service and may correspond to an application, QoS flow, traffic profile, any combination thereof and/or any other appropriate type of parameter.

In 440, the gNB 120A schedules uplink grants for the UE 110. For example, the gNB 120A may identify that the service specific SR corresponds to service X and select an uplink grant pattern based on the service information indicated by the service specific SR. The UL grant provided in response to the service specific SR may be adapted to the type of service (e.g., service X) that triggered the SR. In 450, the gNB 120A transmits an UL grant to the UE 110. For example, the gNB 120A may begin transmission of an UL grant pattern. In 460, the UE 110 performs a data transmission using the resources indicated by the UL grant.

Using multiple SR configurations for different services may reduce latency compared to legacy approaches. For example, a legacy SR mechanism may comprise i) a SR transmission, ii) a first UL grant to cover a buffer status report (BSR), iii) a BSR transmission and iv) a second UL grant for UL data tailored according to the reported BSR and the gNB's resource planning for UL data. Each of these signals necessarily introduce some latency into the UL scheduling process. In another example, a legacy configured grant (CG) mechanism may comprise i) a configured periodic UL grant to cover a BSR, ii) a BSR transmission and iii) a second UL grant tailored according to the reported BSR and the gNB's resource planning for UL data. Similarly, each of these signals necessarily introduce some latency into the UL scheduling process. In contrast to the legacy approaches referenced above, the service specific SR may allow the network to immediately know the UEs expectations without using the need for the transmission of the legacy BSR.

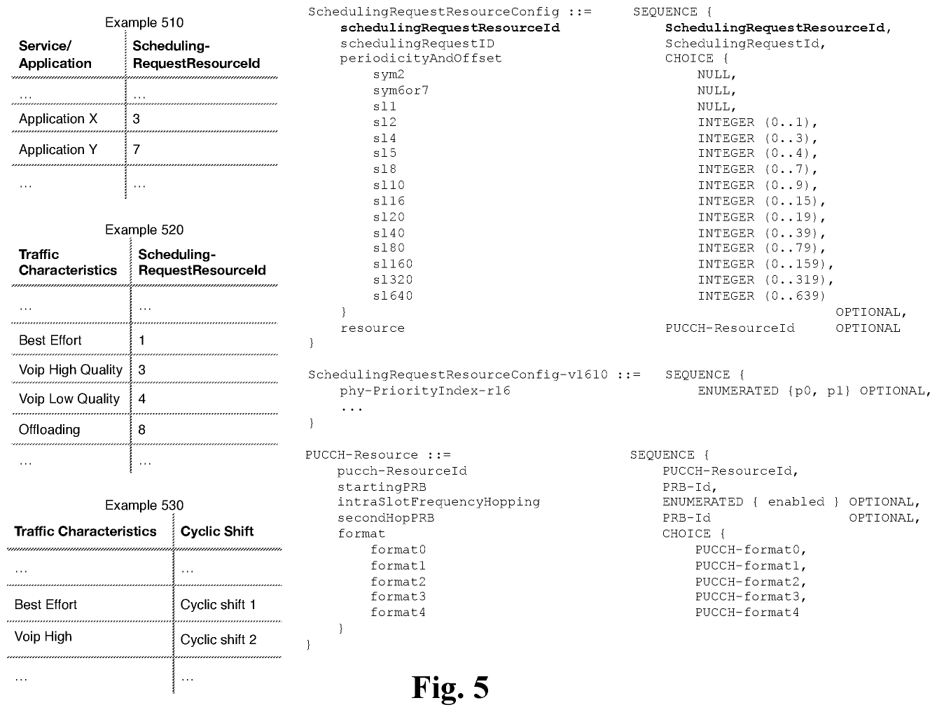

FIG. 5 shows examples of multiple SR configurations according to various exemplary embodiments. In the examples 510-530 described below, the UE 110 and the network may be aware of a mapping between a SR configuration and a particular service/application or a mapping between a SR configuration and certain types of traffic characteristics. From the perspective of the UE 110, the mapping may be derived from a SIM card, network settings, configuration information provided by the network and/or any other appropriate source.

In example 510, application X is mapped to schedulingRequestResourceID “3” and application Y is mapped to schedulingRequestResourceID “7.” During operation, the UE 110 may be configured by a SchedulingRequestResourceConig information element (IE) comprising a schedulingRequestResourceID, a schedulingRequestID and a PUCCH-ResourceID. When the UE 110 is triggered to request an uplink grant for application X, the UE 110 may utilize the configuration information associated with schedulingRequestResourceID “3.” For example, the UE 110 may transmit a service specific SR comprising the indicated schedulingRequestID on the indicated PUCCH resources. The known mapping between application X and the schedulingRequestResourceID enables the network to immediately know that the SR is for application X. Similarly, when the UE 110 is triggered to request an uplink grant for application Y, the UE 110 may utilize the configuration information associated with schedulingRequestResourceID “7.” The UE 110 may transmit a service specific SR comprising the indicated schedulingRequestID on the indicated PUCCH resources. The known mapping between application Y and the schedulingRequestResourceID enables the network to immediately know that the SR is for application Y.

In example 520, different types of traffic characteristics (e.g., traffic profiles) are mapped to different schedulingRequestResourceIDs. Best effort traffic corresponds to schedulingRequestResourceID “1,” voice over IP (VoIP) high quality traffic corresponds to schedulingRequestResourceID “3,” VoIP low quality traffic corresponds to schedulingRequestResourceID “4” and offloading traffic corresponds to schedulingRequestResourceID “8.” During operation, the UE 110 may be configured by multiple SchedulingRequestResourceConig IEs each comprising a schedulingRequestResourceID, a schedulingRequestID and a PUCCH-ResourceID. When the UE 110 is triggered to request an uplink grant for an application or service associated with a certain type of traffic profile (e.g., best effort, VoIP, offloading, etc.), the UE 110 may utilize the configuration information associated with the relevant schedulingRequestResourceID. For example, the UE 110 may transmit a service specific SR for VoIP high quality traffic comprising the schedulingRequestID on the PUCCH resources indicated by the schedulingRequestResourceID “3.” The known mapping between VoIP high quality traffic and the schedulingRequestResourceID enables the network to immediately know that the SR is for VoIP high quality traffic.

Instead of a particular ID, each SR configuration may be associated with a different cyclic shift (e.g., PUCCH sequence, Zadoff-Chu sequence, etc.). An example of this is shown in 530 where a traffic profile for best effort traffic is mapped to cyclic shift “1” and a traffic profile for VoIP high quality traffic is mapped to cyclic shift “2.” During operation, when the UE 110 is triggered to request an uplink grant for an application or service, the UE 110 may utilize the cyclic shift mapped to the corresponding traffic profile. For example, the UE 110 may transmit a service specific SR using cyclic shift 2 for an application or service corresponding to a VoIP high quality traffic profile. The known mapping between the traffic profile and the cyclic shift enables the network to immediately know that the SR is a particular type of traffic. The examples 510-530 described above are not intended to limit the exemplary embodiments in any way. Instead, 510-530 are non-limiting examples of how different applications/services, traffic profiles or any other appropriate parameter may be mapped to a specific SR configuration.

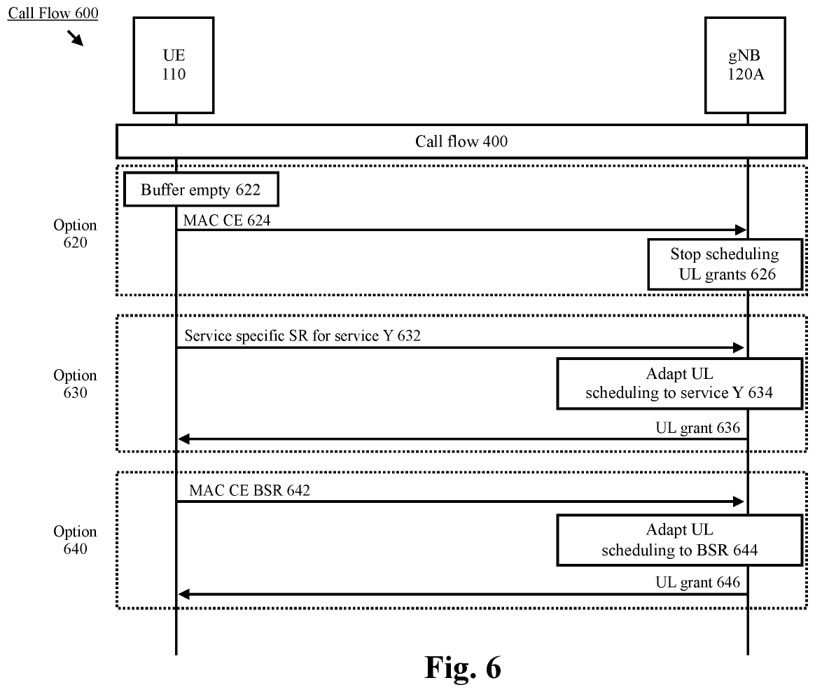

Returning to the call flow 400 of FIG. 4, after the UL grant 450, there are multiple approaches that may be used to handle subsequent UL grants for the UE 110. Three exemplary approaches are described below with regard to the call flow 600 of FIG. 6.

FIG. 6 shows an exemplary call flow 600 according to various exemplary embodiments. It may be assumed each of the three options 620-640 introduced below follow the call flow 400 of FIG. 4.

Initially, the call flow 400 occurs. In a first option 620, the network continues the same opportunistic scheduling based on the service specific SR until the UE 110 indicates that there is no more UL data to send for at least a certain time duration. The UE 110 may provide this indication using a medium access control (MAC) control element (CE). In some embodiments, a dedicated MAC CE is introduced to indicate that the network may stop scheduling UL grants in response to the service specific SR. In other embodiments, this may be indicated using an already defined MAC CE comprising padding or any other appropriate type of indication. Accordingly, in this example, the network may continue to provide UL grants to the UE 110 for traffic corresponding to service X. In 622, a buffer associated with service X is empty. In 624, the UE 110 transits a MAC CE to the gNB 120A. The MAC CE may indicate to the gNB 120A that there is no more data to be transmitted for service X. In 626, the network may stop scheduling uplink grants for the UE 110 (e.g., service X) in response to the MAC CE.

In a second option 630, the network adapts the opportunistic scheduling to a second different subsequently received service specific SR. Option 630 encompasses a scenario in which the UE 110 sends a scheduling request for service X (e.g., 430) and then receives an uplink grant for service X (e.g., 450). In 632, the UE 110 sends a service specific SR for service Y. In 634, the network adapts the UL scheduling to service Y. In 636, the gNB 120A transmits an UL grant to the UE 110 for UL data corresponding to service Y.

In a third option 640, the network relies on a BSR to adapt further UL scheduling to the UE 110. Thus, after the UE 110 receives an uplink grant in response to a service specific SR (e.g., 450), in 642, the UE 110 transmits a MAC CE comprising a BSR to the gNB 120A. In 644, the network may then adapt the UL scheduling based on the BSR. In 646, the network may transmit an UL grant to the UE 110 for the BSR.

According to some aspects of the exemplary embodiments introduce a periodic cadence report (PCR) mechanism. The UE 110 may know specific characteristics of upcoming traffic in advance. For example, the UE 110 may know traffic characteristics such as, but not limited to, the number of upcoming streams, protocols, packet sizes, cadence, jitter constraints, and estimated times of arrival (ETAs). These type of traffic characteristics are becoming more dynamic and there is a need for a more efficient way of controlling the scheduling based on these dynamic conditions. To provide some non-limiting examples, video streaming, audio streaming, and application casting may adapt their respective codecs based on measured end-to-end latency or may be added or removed from data sessions. Even when these services are dynamically scheduled and out of control of the network, they may remain predictable. Scheduling that considers these specific characteristics more dynamically is thus beneficial for the user experience.

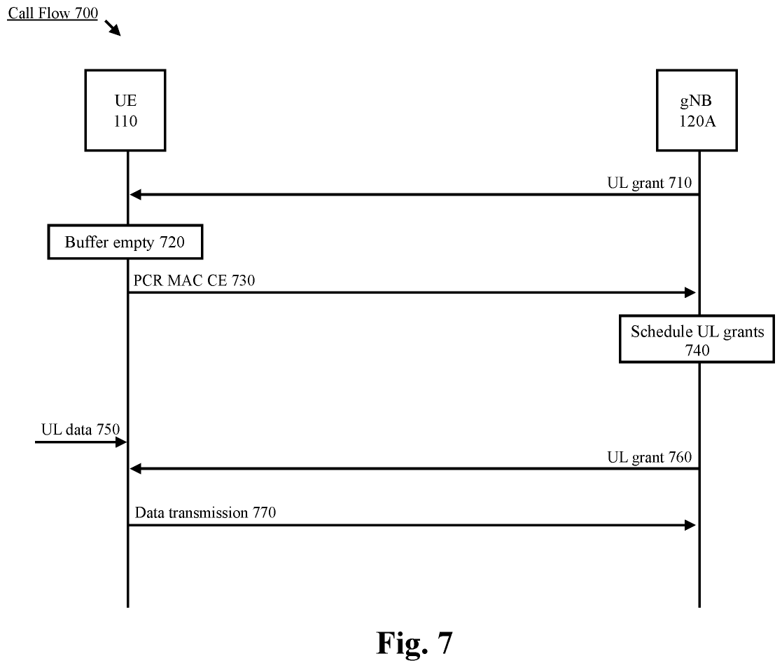

FIG. 7 shows a call flow 700 for a dynamic grant scheme using a PCR according to various exemplary embodiments. The call flow 700 is described with regard to the network arrangement 100 of FIG. 1 and includes the UE 110 and the gNB 120A.

In 710, the UE 110 receives an UL grant from the gNB 120A. In 720, the UE 110 buffers are empty. In 730, the UE 110 transmits a PCR MAC CE to the gNB 120A. The PCR may convey to the network traffic characteristics for subsequent UL data. For example, an application running on the UE 110 may trigger the UE 110 to establish a connection for UL data. The application may inform the UE 110 about expected UL traffic characteristics. The UE 110 may provide this information to the network in the PCR which enables the network to estimate when UL data will arrive at the UE 110 (e.g., 750).

In 740, the gNB 120A schedules an UL grant. The UL grant may be scheduled based on the expected UL needs of the UE 110. For example, the PCR may comprise information indicating that UL data 750 is to arrive at the UE 110 at a first time from a service/application running at the UE 110. In 760, the gNB 120A transmits the UL grant to the UE 110. Since the network was aware of the expected UL data traffic characteristics, the gNB 120A was able to provide the UE 110 with an UL grant for the UL data 750 without the UE 110 transmitting an explicit SR. In 770, the UE 110 performs a data transmission using the uplink resources indicated by the UL grant. The exemplary dynamic grant scheduling mechanism described above may be performed in addition to or instead of a BSR.

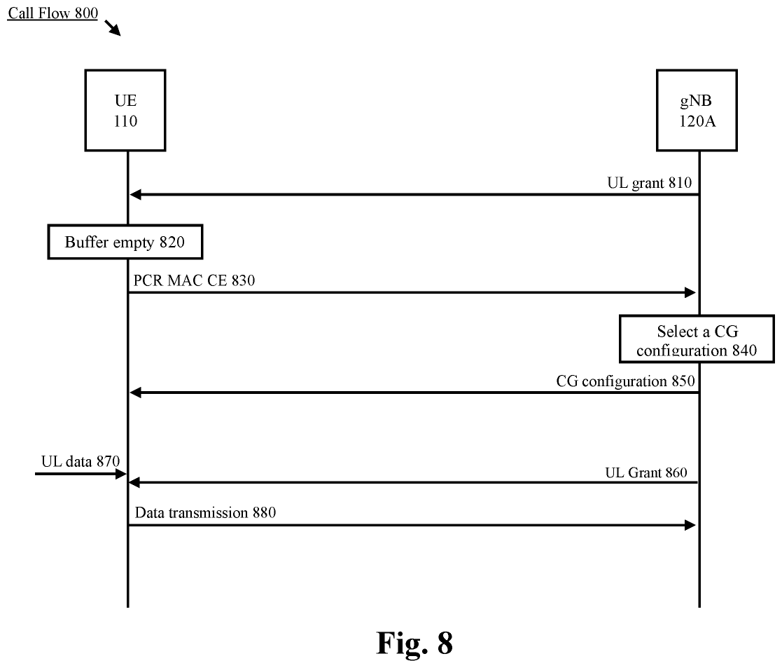

FIG. 8 shows a call flow 800 for a configured grant scheme using a PCR according to various exemplary embodiments. The call flow 800 is described with regard to the network arrangement 100 of FIG. 1 and include the UE 110 and the gNB 120A. In FIG. 8, 810-830 follow a substantially similar procedure to that described with regard to 710-730 of FIG. 7.

In 840, the gNB 120A selects a CG configuration based on the PCR. For example, the network may select a CG configuration with a time domain configuration that includes UL grants that align with the expected UL traffic characteristics indicated by the PCR. In 850, the gNB 120A transmits the selected CG configuration to the UE 110. The selected CG configuration may be indicated to the UE 110 via downlink control information (DCI), radio resource control (RRC) reconfiguration, a new MAC CE dedicated for this purpose, an already defined MAC CE configured to explicitly or implicitly indicate the CG configuration or any other appropriate type of indication.

In 860, the gNB 120A transmits an UL grant to the UE 110. The UL grant may be transmitted in accordance with the CG configuration. In this example, since the CG configuration was selected based on the PCR, the UL grant coincides with the arrival of UL data 870 at the UE 110. In 880, the UE 110 performs a data transmission on the resources indicated by the UL grant.

The enhancements described above allow the network to setup, reconfigure, and release CGs based on the needs of the UE 110. In some embodiments, the network may activate a CG configuration based on the PCR, via RRC for Type 1, DCI for Type 2 or even with a newly introduced MAC CE pointing to a CG configuration to be activated.

In some embodiments, the UE 110 may send PCR periodically or based on the occurrence of an event (e.g., when the modem buffers are emptied to inform when the next UL grant is expected or upon change of traffic patterns). In some embodiments, the UE 110 may send PCRs indicating upcoming scheduling changes (e.g., to allow applications to adapt to jitter) to the network. In some embodiments, as will be described in more detail below, a network configured PCR prohibit timer may be implemented to avoid abuse of frequent PCRs changing the grant scheduling back and forth.

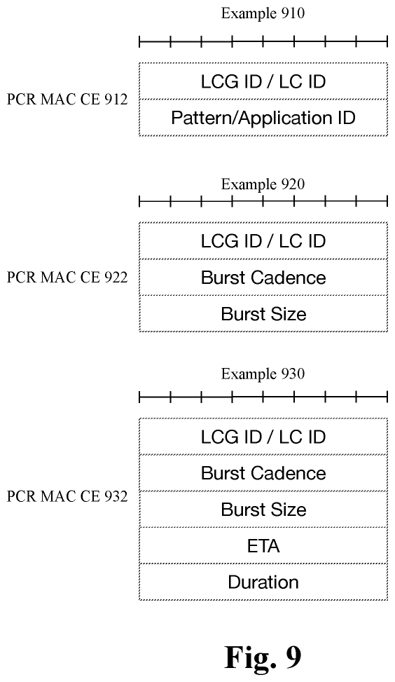

FIG. 9 shows examples of PCR MAC CEs according to various exemplary embodiments. In example 910, the PCR MAC CE 912 comprises a first field for a logical channel (LC) ID and/or a logical channel group (LCG) ID and a second field for a pattern or application ID. The pattern or application ID may represent a value that is mapped to additional information. For example, the application ID may indicate a type of application or traffic profile that is to be used by the UE 110. In another example, the pattern ID may indicate a type of CG pattern that may align with the UL needs of an application running on the UE 110.

In example 920, the PCR MAC CE 922 comprises a first field for a LC ID and/or an LCG ID. The PCR MAC CE 922 further comprises a second field for a burst cadence and a third field for a burst size. The burst cadence may indicate an expected pattern and/or number of data transmissions to be performed by the UE 110 and the burst size may indicate an expected size of the data to be provided by the UE 110.

In example 930, the PCR MAC CE 932 comprises a first field for a LC ID and/or an LCG ID. The PCR MAC CE 932 further comprises a second field for a burst cadence and a third field for a burst size. The PCR MAC CE 932 further comprises a fourth field indicating an expected time of arrival (ETA) for UL data arrival at the UE 110 and a fifth field indicating an UL data transmission duration. The exemplary embodiments are not limited to these examples and may utilize a MAC CE or any other appropriate type of message configured in any appropriate manner to convey the PCR to the network.

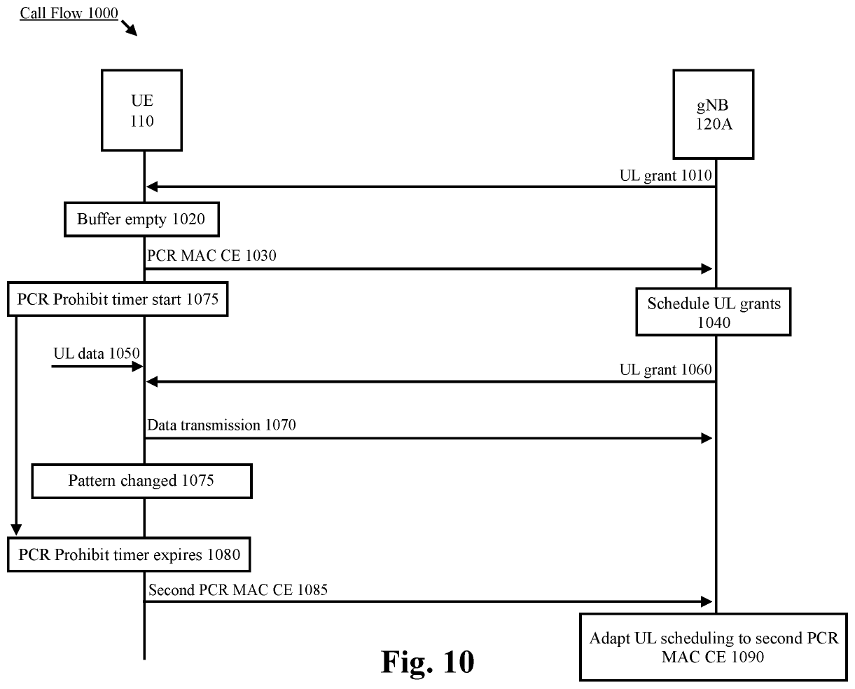

FIG. 10 shows a call flow 1000 for a PCR scheme using a PCR prohibit timer according to various exemplary embodiments. In FIG. 10, 1010-1070 are substantially similar to 710-770 as depicted in FIG. 7.

At 1075, a PCR prohibit timer is initiated. At 1080, the data transmission pattern for the UE 110 is changed. For example, an event or condition may occur that cause an application running on the UE 110 to change the type of amount of UL data to be provided to the network. However, the UE 110 is prohibited from sending another PCR to the network until the expiration of the PCR prohibit timer. In 1080, the PCR prohibit timer expires. Upon expiration of the PCR prohibit timer, the UE 110 may send a second PCR MAC CE 1085 to the gNB 120A to indicate the updated UL traffic characteristics. In 1090, the network may adapt scheduling based on the information provided in the second PCR.

In contrast to a PCR, a BSR may only provide a quantized snapshot of one or more UE 110 buffers to the network. The network may stop scheduling the UE 110 after the buffers are empty. As a result, an SR may be needed upon arrival of new UL data at the UE 110. This may introduce latency and requires additional radio resources. The exemplary PCR introduced herein may convey information that may enable the network to understand what the traffic from a plurality of UEs is expected to look like and how that traffic is expected to change over time. Accordingly, the network may utilize resources more efficiently while achieving lower latencies.

The PCR allows for alignment of the UL grant with the ETA and/or to the cadence of incoming UL data at the UE 110. According to some aspects, the network may utilize a time window during which the UE 110 would expect the dynamic grant which allows for enhanced load balancing and different algorithms to empty the UEs' buffers. The time window may vary based on indicated latency and/or jitter requirements on the UE side. In addition, the PCR allows for latency and jitter to be considered more dynamically in scheduling. Further, the PCR allows for applications to influence the PCR based upon inputs from application, services, and radio frequency (RF) conditions.

In contrast to the exemplary PCR introduced herein, UE assistance information is carried over RRC signaling, which requires more processing for longer periods of time. The exemplary PCR MAC CEs allow signaling to be performed closer to real-time and requires less overhead compared to UE assistance information. Additionally, adding scheduling assistance data inline with the data itself is less complex because the MAC has to maintain the expected grants (grant windows) and related MAC CEs like BSR as well.

According to some aspects, both service-specific SRs and the exemplary PCR mechanism introduced herein may be utilized together. For example, a service-specific SR may deliver a starting point for the network to operate on and provide better-fitting grants to the UE 100. Adding the PCR mechanism offers further refinement of the expectations on the UE-side over time in a more granular manner than a BSR.

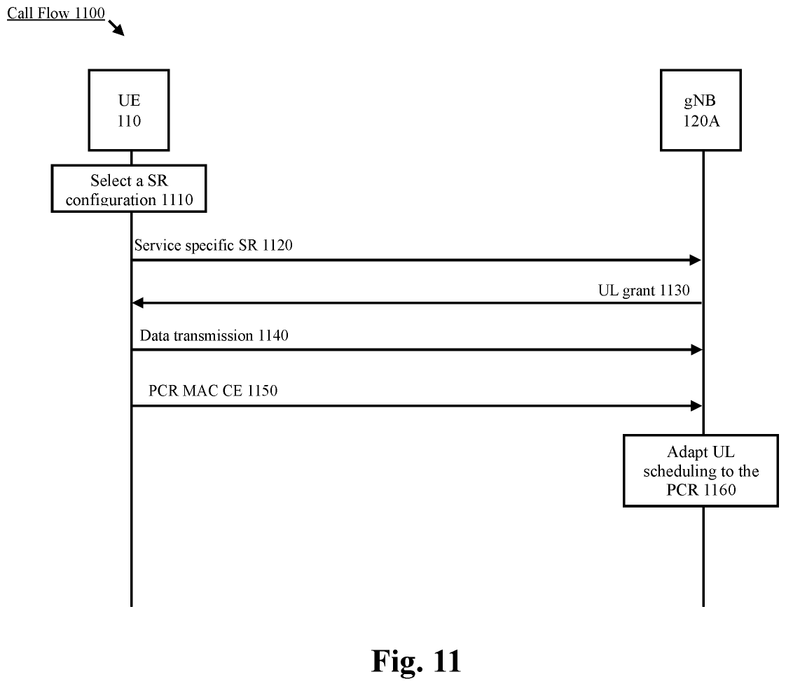

FIG. 11 shows a call flow 1100 for a hybrid scheme utilizing both service specific SR and PCR according to various exemplary embodiments. The call flow 1100 is described with regard to the network arrangement 100 of FIG. 1 and includes the UE 110 and the gNB 120A.

In 1110, the UE 110 selects one of multiple SR configurations. As described above, the multiple SR configurations may correspond to different applications, services, QoS flows, or traffic profiles. The multiple SR configurations may differ in time domain configuration, frequency domain configuration and/or cyclic shift.

In 1120, the UE 110 transmits a service specific SR to the gNB 120. For example, service X may be running on the UE 110 and generate UL data. The service specific SR may be for the UL data generated for service X. In 1130, the gNB 120A transmits an uplink grant to the UE 110. In this example, the UL grant may be for the UL needs of Service X. Thus, an initial uplink grant may be configured to accommodate a specific service that triggered the SR. In 1140, the UE 110 performs a data transmission on the uplink resources indicated by the UL grant. In 1150, the UE 110 transmits a PCR MAC CE to the gNB 120A. In 1160, the network adapts UL scheduling to the information provided in PCR.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above-described method may be embodied as a program containing lines of code stored on a non-transitory computer readable storage medium that, when compiled, may be executed on a processor or microprocessor.

Although this application described various aspects each having different features in various combinations, those skilled in the art will understand that any of the features of one aspect may be combined with the features of the other aspects in any manner not specifically disclaimed or which is not functionally or logically inconsistent with the operation of the device or the stated functions of the disclosed aspects.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured to perform operations comprising:
transmitting a medium access control (MAC) control element (CE) comprising a periodic cadence report (PCR) to a network, wherein the PCR indicates one or more characteristics of upcoming uplink traffic; and
receiving an uplink grant for a data transmission from the network, wherein the uplink grant indicates uplink resources assigned to the UE based on the PCR.

2. The processor of claim 1, wherein the MAC CE is transmitted prior to receiving a first packet in a UE uplink buffer.

3. The processor of claim 1, wherein a scheduling request (SR) is not transmitted to the network by the UE in a duration between transmitting the MAC CE and receiving the uplink grant.

4. The processor of claim 1, the operations further comprising:
receiving, after transmitting the MAC CE and prior to receiving the uplink grant, a signal from the network indicating a configured grant (CG) configuration to be used by the network for the upcoming traffic.

5. The processor of claim 4, wherein the signal comprises downlink control information (DCI).

6. The processor of claim 4, wherein the signal comprises a radio resource control (RRC) reconfiguration message.

7. The processor of claim 4, wherein the signal comprises a second MAC CE.

8. The processor of claim 1, wherein the MAC CE comprises at least an application ID or a pattern ID.

9. The processor of claim 1, wherein the MAC CE comprises at least a burst cadence parameter and a burst size parameter.

10. The processor of claim 1, wherein the MAC CE comprises at least an estimated time of arrival (ETA) parameter and a duration parameter.

11. The processor of claim 1, wherein the UE is prohibited from transmitting a second MAC CE comprising a PCR when a timer is running.

12. A base station processor configured to perform operations comprising:
receiving, from a user equipment (UE), a medium access control (MAC) control element (CE) comprising a periodic cadence report (PCR) that indicates one or more characteristics of upcoming uplink traffic from the UE; and
transmitting an uplink grant for a data transmission to the UE, wherein the uplink grant indicates one or more uplink resources assigned to the UE based on the PCR.

13. The processor of claim 12, wherein a scheduling request (SR) is not received from the UE in a duration between receiving the MAC CE and transmitting the uplink grant.

14. The processor of claim 12, the operations further comprising:
transmitting, after receiving the MAC CE and prior to transmitting the uplink grant, a signal to the UE indicating a configured grant (CG) configuration to be used for the upcoming traffic.

15. The processor of claim 14, wherein the signal comprises downlink control information (DCI).

16. The processor of claim 14, wherein the signal comprises a radio resource control (RRC) reconfiguration message.

17. The processor of claim 14, wherein the signal comprises a second MAC CE.

18. The processor of claim 12, wherein the MAC CE comprises at least an application ID or a pattern ID.

19. The processor of claim 12, wherein the MAC CE comprises at least a burst cadence parameter and a burst size parameter.

20. The processor of claim 12, wherein the MAC CE comprises at least an estimated time of arrival (ETA) parameter and a duration parameter.
